(19) United States
(12) Patent Application Publication
(10) Pub. No.: US 2024/0378749 A1
(43) Pub. Date: Nov. 14, 2024

(54) TRAINING DATA AUGMENTATION DEVICE AND METHOD FOR 3D POSE ESTIMATION

(71) Applicant: SEOUL NATIONAL UNIVERSITY R&DB FOUNDATION, Seoul (KR)

(72) Inventors: Sungchan PARK, Seoul (KR); Joonseok LEE, Seoul (KR); Eunyi LYOU, Seoul (KR); Inhoe LEE, Seoul (KR)

(21) Appl. No.: 18/656,127

(22) Filed: May 6, 2024

(30) Foreign Application Priority Data
May 8, 2023 (KR) 10-2023-0059297

(51) Int. Cl. G06T 7/73

(52) U.S. Cl. CPC G06T 7/74; G06T 2207/20081; G06T 2207/30004; G06T 2207/30196

(57) ABSTRACT

A training data augmentation method for three-dimensional (3D) pose estimation includes collecting foot coordinates of each of persons appearing in a two-dimensional image, estimating a ground plane in a three-dimensional space based on the collected foot coordinates, generating three-dimensional pose data by moving or rotating at least one person or moving or rotating the ground plane based on two basis vectors perpendicular to a normal vector of the ground plane, mapping the 3D pose data to two-dimensional pose data based on a focal length of a camera obtained by capturing the two-dimensional image and a principal point of coordinates of the two-dimensional image, and acquiring a pair of the 3D pose data and two-dimensional pose data as training data.

### CROSS-REFERENCE TO RELATED APPLICATION

This application is based on and claims priority under 35 U.S.C. § 119 to Korean Patent Application No. 10-2023-0059297, filed on May 8, 2023, in the Korean Intellectual Property Office, the disclosure of which is incorporated by reference herein in its entirety.

### BACKGROUND

The present disclosure relates to training data augmentation device and method for three dimensional (3D) pose estimation, and more specifically, training data augmentation device and method for 3D pose estimation which augments training data required to train an artificial intelligence model that estimates a 3D pose. 3D pose estimation is divided into 3D single-person pose estimation (3DSPPE) and 3D multi-person pose estimation (3DMPPE) depending on the number of subjects.

While 3DSPPE has already been extensively studied and used in many applications, 3DMPPE is still uncharted territory having models that are barely applicable to wild scenarios.

In addition, there are three unresolved problems in conventional models developed to estimate a pose.

First, the existing models may not be applied to invisible views (for example, unusual camera angles or distances). The most existing models trained with limited amounts of data operate well only in test examples captured from similar views, and performance thereof degrades significantly when applied to unseen views.

Second, occlusion is another long-standing problem that most existing models still suffer therefrom. Ambiguity may not be avoided because there are multiple plausible answers due to key points hidden from view. When a person completely blocks another person from a camera, occlusion becomes much more severe, causing a model output to make inconsistent estimates across frames.

Third, the existing models often generate a series of 3D poses with severe shaking.

In particular, a motion capture system has traditionally been used to generate training data pairs necessary for training an artificial intelligence (AI) model that estimates a 3D pose from two-dimensional (2D) input data, but this method has very large spatial and temporal constraints and cost constraints, and accordingly, there is a problem that a range of data which may be used for research is also very limited.

An example of related art includes Korean Patent No. 10-2462799.

### SUMMARY

Therefore, the present disclosure proposes an artificial intelligence model that estimates a 3D pose from 2D input data and prevents occlusion due to a wild video, and provides training data augmentation device and method for 3D pose estimation that increases cost efficiency and are not limited by temporal and spatial constraints by combining and adjusting single-person data to collect data required for training an artificial intelligence model.

Objects of the present disclosure are not limited to the objects described above, and other objects not described will be clearly understood by those skilled in the art from descriptions below.

According to an aspect of the present disclosure, a training data augmentation method for three-dimensional (3D) pose estimation includes collecting foot coordinates of each of persons appearing in a two-dimensional image, estimating a ground plane in a three-dimensional space based on the collected foot coordinates, generating three-dimensional pose data by moving or rotating at least one person or moving or rotating the ground plane based on two basis vectors perpendicular to a normal vector of the ground plane, mapping the 3D pose data to two-dimensional pose data based on a focal length of a camera obtained by capturing the two-dimensional image and a principal point of coordinates of the two-dimensional image, and acquiring a pair of the 3D pose data and two-dimensional pose data as training data.

According to another aspect of the present disclosure, a training data augmentation device for 3D pose estimation includes a processor, and a memory connected to the processor and storing at least one code executed by the processor, wherein the processor is configured to perform an operation of collecting foot coordinates of each of persons appearing in a two-dimensional image, an operation of estimating a ground plane in a three-dimensional space based on the collected foot coordinates, an operation of generating three-dimensional pose data by moving or rotating at least one person or moving or rotating the ground plane based on two basis vectors perpendicular to a normal vector of the ground plane, an operation of mapping the 3D pose data to two-dimensional pose data based on a focal length of a camera obtained by capturing the two-dimensional image and a principal point of coordinates of the two-dimensional image, and an operation of acquiring a pair of the 3D pose data and two-dimensional pose data as training data.

### BRIEF DESCRIPTION OF THE DRAWINGS

Embodiments of the inventive concept will be more clearly understood from the following detailed description taken in conjunction with the accompanying drawings in which:

FIG. 1 schematically illustrates three-dimensional (3D) pose estimation according to an embodiment;

FIG. 2 is a block diagram schematically illustrating a configuration of a 3D pose estimation device according to an embodiment;

FIG. 3 is a conceptual diagram illustrating a 3D pose estimation model according to an embodiment of the present disclosure, and illustrates the entire workflow;

FIG. 4 illustrates examples of a two-dimensional (2D)-to-3D lifting transformer;

FIG. 5 illustrates examples of training data augmentation method of the present disclosure;

FIG. 6 is an example diagram expressing a simple volume of a person; and FIG. 7 is a flowchart illustrating a training data augmentation method for 3D pose estimation according to an embodiment of the present disclosure.

### DETAILED DESCRIPTION OF THE EMBODIMENTS

Objects and effects of the present disclosure and the technical configurations for achieving the objects and effects will become clear by referring to embodiments described in detail below along with the attached drawings. In describing the present disclosure, when it is determined that a detailed description of the known function or configuration may unnecessarily obscure the gist of the present disclosure, the detailed description will be omitted. Terms described below are defined in consideration of a structure, role, and function of the present disclosure and may change depending on the intention or custom of a user or operator.

However, the present disclosure is not limited to embodiments disclosed below and may be implemented in various different forms. The examples are merely provided to ensure that the disclosure of the present disclosure is complete and to fully inform those skilled in the art to which the present disclosure belongs, and the present disclosure is defined solely by the scope of the claims stated in the claims. Therefore, the definition should be made based on the contents throughout the present specification.

Throughout the specification, when it is said that a portion or unit “includes” a certain element, this means that the portion or unit may further include other elements, rather than excluding other elements, unless specifically stated to the contrary.

Hereinafter, preferred embodiments of the present disclosure will be described in more detail with reference to the attached drawings.

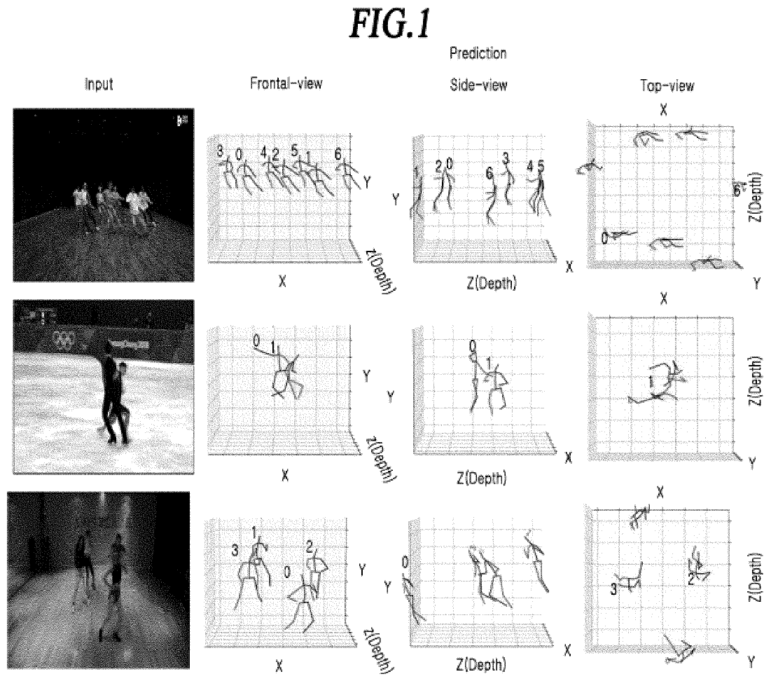

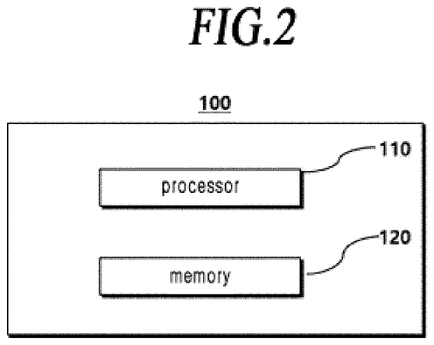

FIG. 1 schematically illustrates three-dimensional (3D) pose estimation according to an embodiment, and FIG. 2 is a block diagram schematically illustrating a configuration of a 3D pose estimation device according to an embodiment;

A 3D pose estimation device 100 according to the embodiment illustrates the performance of a 3D pose estimation model in several examples of a wide video. Referring to FIG. 1, it can be seen that the 3D pose estimation model accurately estimates 3D poses of multiple persons despite occlusion between the multiple persons.

In order to train the 3D pose estimation model, a training data pair required to train an artificial intelligence (AI) model that estimates a 3D pose from two-dimensional (2D) input data is mainly augmented.

A motion capture system for generating the training data pair is used in the related art, but spatial and temporal constraints and cost constraints are very large, and the motion capture system is limited to a method of reversing a person's pose and is passive in augmenting training data.

The present disclosure may greatly contribute to increasing the performance of a 3D pose estimation model by significantly increasing diversity and scope of training data augmentation.

3D pose estimation is divided into 3D single-person pose estimation (3DSPPE) and 3D multi-person pose estimation (3DMPPE) depending on the number of subjects.

The present disclosure deals with a 3DMMPE model (hereinafter referred to as a 3D pose estimation model) that reproduces 3D coordinates of body key points of all persons appearing in a video.

The 3D pose estimation model according to the present disclosure provides a new data augmentation strategy for generating training data by processing the existing one-person pose data to avoid collecting real data that requires high costs.

The present disclosure mainly deals with the 3DMPPE, which reproduces the 3D coordinates of the body key points of all persons appearing in a video.

In addition, the present disclosure provides a following solution to reduce occlusion A main reason for occlusion in the existing model is that one frame (frame-to-frame) is processed at a time. The present disclosure performs preprocessing to effectively process multiple frames (seq-to-seq) at a time for the 3DSPPE, and the 3D pose estimation model may naturally be extended to multiple users by adopting a similar transformer-based 2D-to-3D structure.

The 3D pose estimation model may track multiple persons simultaneously by adding self-attention to multiple persons appearing in a video.

Hereinafter, 3D pose estimation is described.

As illustrated in FIG. 2, the 3D pose estimation device 100 includes a processor 110.

The processor 110 is a type of central processing unit and may execute one or more instructions stored in a memory 120 to perform a training data augmentation method for 3D pose estimation according to the embodiment. The processor 110 may include all types of devices capable of processing data.

For example, the processor 110 may refer to a data processing device which that includes a physically structured circuit to perform a function expressed by code or instructions included in a program and is built in hardware. For example, the data processing device built in hardware, may include a microprocessor, a central processing unit (CPU), a processor core, a multiprocessor, application-specific integrated circuit (ASIC), a field programmable gate array), a field programmable gate array (FPGA), graphics processing unit (GPU), and so on but is not limited thereto. The processor 110 may include one or more processors. The processor 110 may include at least one core.

The 3D pose estimation device 100 according to the embodiment may further include the memory 120.

The memory 120 may store instructions and so on for performing a training data augmentation method for 3D pose estimation by using the 3D pose estimation device 100 according to the embodiment. The memory 120 may store an executable program that implements a training data augmentation technique for 3D pose estimation according to an embodiment and generates and executes one or more instructions.

The processor 110 may perform a memory management method according to an embodiment based on the program and instructions stored in the memory 120.

The memory 120 may include an internal memory and/or external memory and may include a volatile memory, such as dynamic random access memory (DRAM), a static RAM (SRAM), or SDRAM, synchronous DRAM (SDRAM), a nonvolatile memory, such as one time programmable read only memory (OTPROM), programmable ROM (PROM), electrically programmable ROM (EPROM), electrically erasable and programmable ROM (EEPROM), mask ROM, flash ROM, NAND flash memory, or NOR flash memory, and a storage device, such as an solid state drive (SSD), a compact flash (CF) card, a secure digital (SD) card, a micro-SD card, a mini-SD card, an extreme digital (xD) card, a memory stick, or a hard disk drive (HDD). The memory 120 may include magnetic storage media or flash storage media but is not limited thereto.

In the 3DMPPE, an input consists of a video of T frames V=[vᵢ, . . . , V_{T}], where each of the T frames is vₜ∈ [symbol] ^{H×W×3}, and N persons may appear in the video.

An operation of the processor 110 is to find a predefined set of K body key points (for example, neck, ankles, knees, and so on) in a 3D space for every person that appears in every frame of a video. The body key points in a 2D image space are represented by X∈ [symbol] ^{T×N×K×2}, and an output Y∈ [symbol] ^{T×N×K×3} designates 3D coordinates of respective body key points for all of N persons.

Notations. For the sake of convenience of description, a common notation for 2D and 3D points may be defined. A 2D point X_{t,i,k}∈ [symbol] ² is represented by (u, v), where u∈{0, . . . , H1} and v∈{0, . . . , W1} are respectively vertical and horizontal coordinates of an image. Similarly, a 3D Y_{t,i,k}∈ [symbol] ³ is represented by (x,y,z), where x and y are coordinates in two directions parallel to a projected 2D image, and z is a depth from a camera.

Data Preprocessing. The processor 110 may adjust an input in two ways according to common practice.

First, the processor 110 may specifically process a key point called a root joint (generally pelvis and center of the body: Y_{t,i,l}∈ [symbol] ³ for a person i in a frame t.

An actual measurement value for the root joint is given by (u, v, z), where (u, v) is 2D coordinates of the root joint and z is a depth.

In the root joint, the 3D pose estimation model estimates (û, \hat{v}, \hat{z}) which is an absolute value of (u, v, z) û≈u and \hat{v}≈v, but it is still assumed that imperfect 2D pose estimation is compensated by a ready-made model).

Other general joints Y_{t,i,k} ∈ [symbol] ³ (k=2, . . . , K) may be expressed as a relative difference from a corresponding root joint Y_{t,i,1}.

Second, the processor 110 may normalize an actually measured depth of the root joint with a camera focal length. To this end, once a 2D pose is mapped to a 3D space, a depth of each 2D key point towards a projection direction has to be estimated.

An estimated depth is proportional to the camera focal length used for training, an actually measured depth z may be normalized by a focal length according to the known technique. That is z̅=z/f, where f is the camera focal length. In this way, the 3D pose estimation model may operate independently of the camera focal length.

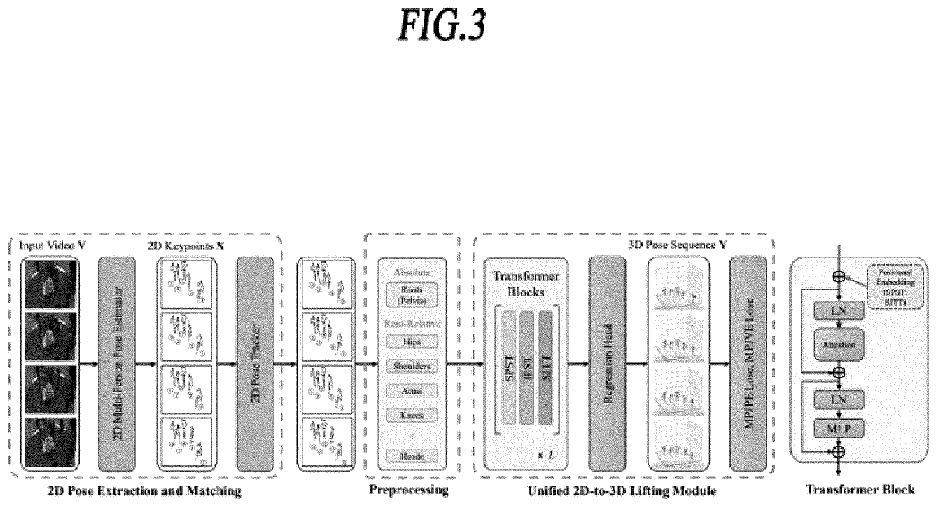

FIG. 3 is a conceptual diagram illustrating the 3D pose estimation model according to an embodiment of the present disclosure and illustrates the entire workflow.

First, an input frame V may be converted into a series of 2D key points by a ready-made model (a first neural network model). The input frame may be lifted to a 3D space.

This will be described in detail below.

### 2D Pose Extraction and Matching

When an input video V∈ [symbol] ^{T×H×W×3} is given, the processor 110 first extracts 2D coordinates X∈ [symbol] ^{T×N×K×2} of all of N persons appearing in the input video.

Here, T is a frame, and K is the number of body key points predetermined by a data set. Since a video deals with multiple persons, each person has to be redefined for every frame. That is, the second index of X and Y has to be consistent for each individual in all frames.

The processor 110 may adopt the known 2D multi-person pose estimator and tracking model to obtain 2D coordinates of a person and may not be limited to types thereof.

Since the processor 110 trains a model in an augmented video where 2D coordinates may be calculated from an actually measured 3D pose and camera parameter, the step is performed at test time.

### 2D-3D Lifting Module

The processor 110 lifts an input X to 3D coordinates Y∈ [symbol] ^{T×N×K×3} through the 2D-3D lifting module. An encoder may be applied for spatial and temporal geometric context.

2D coordinates X_{t,i,k} may be linearly mapped to D-dimensional token embedding

in a specific frame t∈{1, . . . , T} for a specific person i∈{1, . . . , N} and a body key point k∈{1, . . . , K} by the 2D-3D lifting module.

Therefore, an input may be converted now into a token sequence T×N×K of [symbol] ^{D}, and the token may be represented by Z⁽⁰⁾∈ [symbol] ^{T×N×K×D}.

Here, unlike the most existing method of treating a root joint and a general joint separately, the present disclosure uses an integrated model. The integrated model is not only simpler but also allows attention to a depth and pose, and accordingly, more comprehensive estimation may be made.

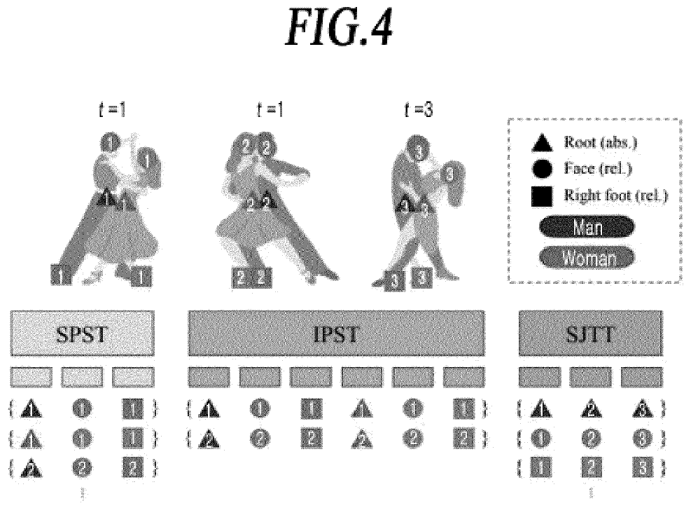

FIG. 4 illustrates examples of a 2D-to-3D lifting transformer.

Referring to FIG. 4, three types of transformers are disclosed, each transformer is designed to model a specific relationship between different body key points. The three types of transformers include two transformers of a single person spatial transformer (SPST) for spatial modeling and a single joint temporal transformer (SJTT) for a temporal relationship, and an inter-person spatial transformer (IPST) which is designed to learn a relationship between persons among all body key points.

In each layer 1, an input [symbol] ∈ [symbol] ^{T×N×K×D} is contextualized within a sequence through the SPST, IPST, and SJTT, and a tensor [symbol] ∈ [symbol] ^{T×N×K×D} of the same size is output.

### Single Person Spatial Transformer (SPST)

The SPST, which is located at the first stage of each layer 1, learns a spatial correlation of joints of each person in each frame.

In the input X∈ [symbol] ^{T×N×K×D}, SPST brings at a time K tokens of a corresponding size D for each t∈{1, . . . , T} and i∈{1, . . . , N} X_{t,i}∈ [symbol] ^{K×D} corresponding to X_{t,i}∈ [symbol] ^{K×D}.

That is, the SPST takes K different body key points belonging to the same person i in a specific frame t.

An output y∈ [symbol] ^{T×N×K×D} has the same appearance, where each token y_{t,i,k} is a contextualized transformation of another token belonging to the same person.

Inter-Person Spatial Transformer (IPST)

After the SPST, the IPST learns a correlation between multiple individuals in the same frame.

Therethrough, a model learns a spatial interpersonal relationship in a scene. The IPST is newly designed to extend the model to 3DMPPE.

More formally, the IPST uses N×K tokens of a size D with one input. That is, when an input X∈ [symbol] ^{T×N×K×D} is given, all of N×K tokens Xₜ∈ [symbol] ^{N×K×D} in the frame are provided to the IPST, contextualized with each other, and converted into an output token Yt.

This process is performed separately for each frame at t=1, . . . , T. After the IPST, each token may know about other persons in the same scene.

### Single Joint Temporal Transformer (SJTT)

An N×K input sequence of a length T corresponding to X_{i,k,}∈ [symbol] ^{T×D} is generated for i=1, . . . , N and k=1, . . . , N from an input X∈ [symbol] ^{T×N×K×D}. Each sequence is supplied to the SJTT to temporally contextualize each token of the sequence, and the converted output token is returned. When the N×K sequence is completed, a converted sequence y∈ [symbol] ^{T×N×K×D} of an Ith layer of the 2D-to-3D lifting module is output as a following result.

These three blocks configure a single layer of the 2D-to-3D lifting module, and multiple layers are stacked.

A learnable position encoding is added to each token in the first layer ( [symbol] =1) of the SPST and SJTT. No positional encoding is added to the IPST because there is no natural sequence between multiple individuals in a video.

### Regression Head

The processor 110 repeats the L layer of SPST, IPST, and SJTT and then obtains output tokens on all body key points Z^{(L)}∈ [symbol] ^{T×N×K×D}. This is input to a regression head consisting of a multilayer perceptron (MLP). Each body key point included in Z^{(L)} is mapped to corresponding 3D coordinates Ŷ∈ [symbol] ^{T×N×K×3}.

### Training Objectives

When a predicted result Ŷ∈ [symbol] ^{T×N×K×3} and an actual value Ŷ∈ [symbol] ^{T×N×K×3}are given, the processor 110 minimizes following two losses.

A mean per joint position error (MPJPE) loss is an average distance L₂ between prediction and a goal.

$${ℒ}_{MPJPE} = \frac{1}{TNK} {{\sum }^{T}}_{t = 1} {{\sum }^{N}}_{i = 1} {{\sum }^{K}}_{k = 1} {‖ {\hat{Y}}_{t , i , k} - {Y}_{t , i , k} ‖}_{2} .$$

A mean per joint velocity error (MPJVE) loss is an average distance L₂ between a first derivative of prediction and a target for time, and the smoothness of a predicted sequence is measured.

$${ℒ}_{MPJVE} = \frac{1}{TNK} {{\sum }^{T}}_{t = 1} {{\sum }^{N}}_{i = 1} {{\sum }^{K}}_{k = 1} {‖ \frac{\partial {\hat{Y}}_{t , i , k}}{\partial t} - \frac{\partial {Y}_{t , i , k}}{\partial t} ‖}_{2} . \qquad ( 2 )$$

A total loss L is a weighted sum of two losses. That is, L=LMPJPE+λ·LMPJVE, where λ controls a relative importance therebetween. Alternatively, different weights may be applied to the root joint and so on.

### Geometry-Aware Data Augmentation

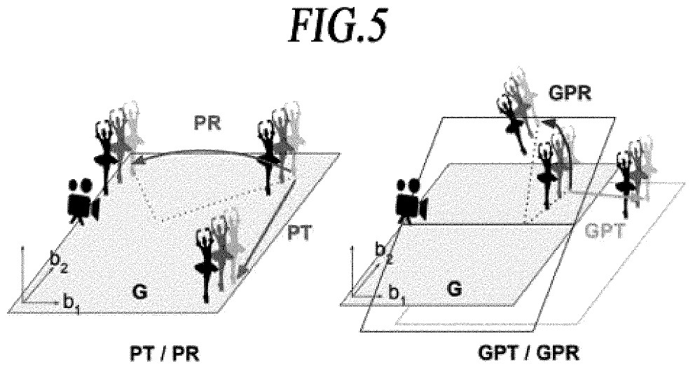

FIG. 5 illustrates examples of training data augmentation method of the present disclosure.

Hereinafter, the training data augmentation method is described with reference to FIG. 5.

Specifically, the processor 110 may take N samples Y⁽ⁱ⁾∈ [symbol] ^{T×K×3} captured by a fixed camera from a one-person data set that is 3D pose data (i=1, . . . , N).

Then, X∈ [symbol] ^{T×N×K×2} may be generated by overlaying N samples on a single video Y∈ [symbol] ^{T×N×K×3} and by projecting a perspective camera model onto a 2D space.

Points (x, y, z) in a 3D space may be mapped to (u, v) by a following relationship.

$$[ \begin{matrix}u \\ v \\ 1\end{matrix} ] \approx [ \begin{matrix}{f}_{u} & 0 & {c}_{u} \\ 0 & {f}_{v} & {c}_{v} \\ 0 & 0 & 1\end{matrix} ] [ \begin{matrix}x \\ y \\ z\end{matrix} ] , \qquad ( 3 )$$

Here, fu and fv are focal lengths and Cu and Cv are main points of 2D image coordinates.

(X, Y) is an augmented 3DMPPE training sample, and repeating this with another sample may generate an infinite number of new samples.

In addition, additional augmentation to a trajectory, such as random transformation or rotation of the trajectory, may be considered to introduce additional randomness and fully utilize the existing data.

However, there are geometric factors to consider, such as a ground plane and potential occlusion.

### Ground-Plane-Aware Augmentations

Geometrically, persons in a video share a common ground plane because their feet touch

the ground, with a few exceptions such as swimming situations.

Considering this situation, the processor 110 collects foot coordinates of each of a plurality of persons appearing in a 2D image.

A ground plane may be estimated by collecting foot coordinates from all frames captured by a fixed camera and fitting the foot coordinates with linear regression to generate a 2D linear manifold ground plane in a 3D space. In addition, two basis vectors bl and b2 perpendicular to a normal vector of a ground plane G may be set.

Subsequently, the processor 110 may combine four augmentation methods, as illustrated in FIG. 5, to generate rich sequences that mimic a variety of multiple persons and camera movements.

That is, the training data may be additionally generated by moving or rotating at least one person based on two basis vectors bl and b2 perpendicular to the normal vector of the ground plane or by moving or rotating the ground plane.

A technique for additionally generating training data may use at least one of person rotation (PR), ground plane translation (GPT), ground plane rotation (GPR), and person translation (PT).

For example, in order to augment the training data, PR, GPT, GPR, and PT may be performed in the order. In this case, in the PT, the center coordinates of each target person may be randomly determined within a range in which the center coordinates are located in front of the camera and have values allowing the center coordinates to be projected onto an image plane.

In detail, a step of additionally generating the training data may include a step (PT: person translation) of moving each target person along two basis vectors representing the ground plane in a three-dimensional space, and a movement amount may be randomly determined in a range in which a central joint position of each target person is located in front of a camera and is projected onto an image plane.

Alternatively, the step of additionally generating the training data may include a step (PR: person rotation) of rotating each target person with respect to a normal vector of a ground plane, and a rotation angle may be randomly determined between −45 degrees and 45 degrees.

Alternatively, the step of additionally generating the training data may include a step (GPT: ground plane translation) of moving a ground plane along a principal axis of a camera, and a movement amount may be determined by considering a relative position from the camera.

Alternatively, the step of additionally generating the training data may include a step (GPR: ground plane rotation) of rotating the ground plane in a direction closer to or away from the camera, and a rotation amount may be randomly determined between −30 degrees and 30 degrees.

Here, the order of augmentation of the training data follows the order of PR, GPT, GPR, and PT, and in the PT, the center coordinates of each target person may be randomly determined within a range in which the center coordinates are located in front of the camera and have values allowing the center coordinates to be projected onto an image plane.

### Reflecting Occlusions

Hereinafter, a solution of the present disclosure for solving the occlusion problem will be described. Occlusion is another long-standing problem that most models still suffer from.

The body has a certain amount of volume, and accordingly, even when two body parts (whether the two body parts are in one person or different persons) do not match to each other, the two body parts may be obscured when two key points are projected close enough. In order for the present disclosure to solve the problem, the processor 110 performs a step

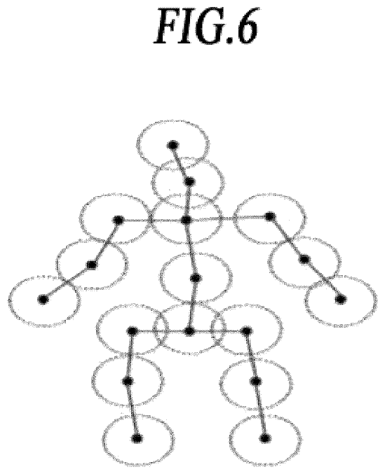

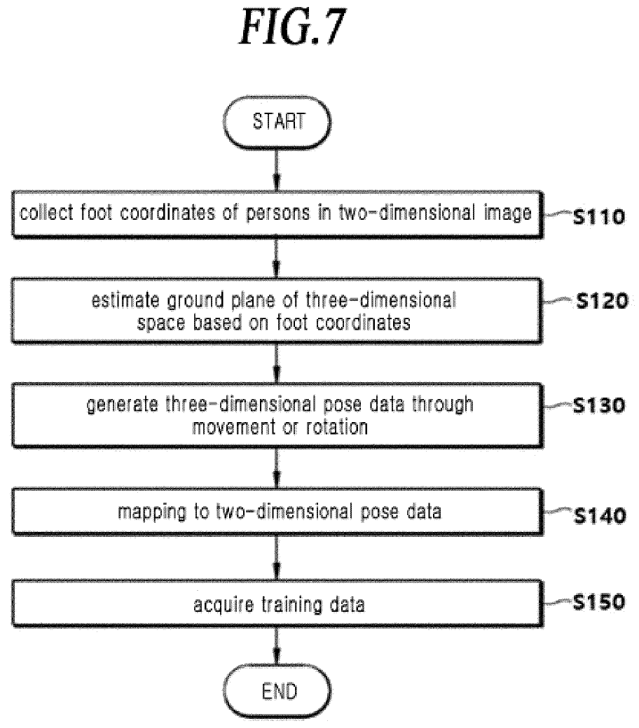

of expressing the volume of each target person as a set of three-dimensional balls centered on each joint (each key point), as illustrated in FIG. 6. That is, the present disclosure proposes a simple volumetric representation of a person, and the volume of each body part is modeled as a 3D ball of the same size centered on a corresponding key point.

The ball may be expressed in the same size at each joint of one target person, balls may be projected onto a 2D image plane as circles, and the radius of each of the circles may be set to be inversely proportional to a distance of the 3D ball from a camera.

To this end, a distance between the centers of the first circle corresponding to the first person and the second circle corresponding to the second person may be measured, and whether the first person occludes the second person may be determined according to a comparison between the radius of the first circle of the first person closer to the camera and a center-to-center distance between the first circle and the second circle.

In other words, circles may be considered to overlap each other when a distance between the centers of two circles is less than the radius of a larger circle. It is considered that a circle with the smaller radius is occluded farther away. When a key point is occluded, a case is simulated in which a key point predicted by a ready-made model with low reliability by disturbing or dropping out with some noise is dropped in inference.

FIG. 7 is a flowchart illustrating a training data augmentation method for 3D pose estimation, according to an embodiment of the present disclosure. Each step in FIG. 7 is performed by a processor, and redundant descriptions thereof are partially omitted.

First, the processor may collect foot coordinates of each person appearing in a 2D image (S110).

Next, a ground plane of a 3D space may be estimated based on the collected foot coordinates (S120).

Next, 3D pose data may be generated by moving or rotating at least one person based on the two basis vectors b1 and b2 perpendicular to a normal vector of the ground plane, or moving or rotating the ground plane (S130).

Here, additional 3D pose data may be generated to augment the training data, and to this end, a technique for additionally generating the 3D pose data may use at least one of PR, GPT, GPR, and PT.

For example, conversion may be performed in the order of PR, GPT, GPR, and PT to generate the 3D pose data. In this case, in the PT, the center coordinates of each target person may be randomly determined within a range in which the center coordinates are located in front of the camera and have values allowing the center coordinates to be projected onto an image plane.

Specifically, in order to additionally generate the 3D pose data as illustrated in FIG. 5, an operation (PT) of moving each target person along the two basis vectors representing the ground plane in a 3D space and an operation of generating the 3D pose data of each target person by the PT may be performed. Here, the amount of movement may be randomly determined within a range in which the central joint position of each target person is located in front of a camera and projected onto an image plane.

In addition, in order to additionally generate the 3D pose data, an operation (PR) of rotating each target person with respect to a normal vector of a ground plane and an operation of generating the 3D pose data of each target person by the PR may be performed, where the rotation angle may be randomly determined between −45 degrees and 45 degrees.

In addition, in order to additionally generate the 3D pose data, an operation (GPT) of moving the ground plane along a principal axis of a camera, and the translation of each target person by the GPT and an operation of generating the 3D pose data of each target person by the GPT may be performed, where a movement amount may be determined by considering relative positions of a plurality of persons from the camera.

In addition, in order to additionally generate the 3D pose data, an operation (GPR) of rotating the ground plane toward or away from the camera and a 3D image of each target person by the GPR and an operation of generating the 3D pose data of each target person by the GPR may be performed, where a rotation amount may be randomly determined between −30 degrees and 30 degrees.

Next, the 3D pose data may be mapped to 2D pose data based on a focal length of a camera that captures a 2D image and a principal point of 2D image coordinates (S140).

To this end, the processor 110 may take N samples Y⁽ⁱ⁾∈ [symbol] ^{T×K×3} (i=1, . . . , N) captured by a fixed camera from a one-person data set (3D pose data).

Subsequently, the N samples may be overlaid on a single video Y∈ [symbol] ^{T×N×K×3} and projected onto a 2D space by applying a perspective camera model to generate X∈ [symbol] ^{T×N×K×2}.

Points x, y, and z in a 3D space may be mapped to u and v by a relationship below.

$$[ \begin{matrix}u \\ v \\ 1\end{matrix} ] \approx [ \begin{matrix}{f}_{u} & 0 & {c}_{u} \\ 0 & {f}_{v} & {c}_{v} \\ 0 & 0 & 1\end{matrix} ] [ \begin{matrix}x \\ y \\ z\end{matrix} ] , \qquad ( 3 )$$

Here fu and fv are focal lengths and Cu and Cv are main points of the 2D image coordinates.

Next, a pair of the 3D pose data and the 2D pose data may be acquired as training data (S150). That is, 3D pose data may be additionally generated through at least one of PR, GPT, GPR, and PT, and 2D pose data corresponding thereto may be mapped, and thereby, the training data that pairs the 3D pose data and the 2D pose data may be augmented.

Meanwhile, in order to solve an occlusion problem, the processor 110 performs a step of expressing the volume of each target person as a set of 3D balls centered on each joint (each key point). That is, a simple volumetric representation of a person is proposed, and the volume of each body part is modeled as a 3D ball of the same size centered on a corresponding key point.

The ball may be expressed in the same size at each joint of one target person, balls may be projected onto a 2D image plane as circles, and the radius of each of the circles may be set to be inversely proportional to a distance of the 3D ball from a camera.

To this end, a distance between the centers of the first circle corresponding to the first person and the second circle corresponding to the second person may be measured, and whether the first person occludes the second person may be determined according to a comparison between the radius of the first circle of the first person closer to the camera and a center-to-center distance between the first circle and the second circle.

In other words, circles may be considered to overlap each other when a distance between the centers of two circles is less than the radius of a larger circle. It is considered that a circle with the smaller radius is occluded farther away. When a key point is occluded, a case is simulated in which a key point predicted by a ready-made model with low reliability by disturbing or dropping out with some noise is dropped in inference.

The method according to an embodiment of the present disclosure described above may be implemented as computer-readable code on a medium on which a program is recorded. Computer-readable media includes all types of recording devices that store data which may be read by a computer system. For example, the computer-readable media may include HDD, SSD, silicon disk drive (SDD), ROM, RAM, compact disk (CD)-ROM, a magnetic tape, a floppy disk, an optical data storage device, and so on.

The training data augmentation device and method for 3D pose estimation according to embodiments of the present disclosure may estimate a 3D pose from 2D input data and prevent occlusion caused by a wide video.

In addition, the training data augmentation device and method for 3D pose estimation may increase cost efficiency and may not be limited by temporal and spatial constraints by processing the existing one-person data to augment the training data required to train an artificial intelligence model.

Effects of the present disclosure are not limited to the effect described above, and other effects not described will be clearly understood by those skilled in the art from the descriptions of the present disclosure.

The descriptions of the embodiments of the present disclosure are for illustrative purposes, and those skilled in the technical field to which the present disclosure pertains may easily convert the embodiments into another specific form without changing the technical idea or essential features of the present disclosure. Therefore, the embodiments described above should be understood in all respects as illustrative and not restrictive. For example, each component described as single type may be implemented in a distributed manner, and similarly, components described in the distributed manner may also be implemented in a combined form.

The scope of the present disclosure is indicated by the claims described below rather than the detailed description above, and all changes or modified forms derived from the meaning and scope of the claims and their equivalent concepts should be interpreted to be included in the scope of the present disclosure.

What is claimed is:

1. A training data augmentation method for three-dimensional (3D) pose estimation, the training data augmentation method comprising:
collecting foot coordinates of each of persons appearing in a two-dimensional image;
estimating a ground plane in a three-dimensional space based on the collected foot coordinates;
generating three-dimensional pose data by moving or rotating at least one person or moving or rotating the ground plane based on two basis vectors perpendicular to a normal vector of the ground plane;
mapping the 3D pose data to two-dimensional pose data based on a focal length of a camera obtained by capturing the two-dimensional image and a principal point of coordinates of the two-dimensional image; and
acquiring a pair of the 3D pose data and two-dimensional pose data as training data.

2. The training data augmentation method of claim 1, wherein
the generating of the 3D pose data includes moving (person translation (PT)) each target person along the two basis vectors representing the ground plane in a 3D space, and generating the 3D pose data of the each target person by the PT, and
a movement amount is randomly determined randomly within a range in which a central joint position of the each target person is located in front of a camera and projected onto an image plane.

3. The training data augmentation method of claim 1, wherein
the generating of the 3D pose data includes rotating (person rotation (PR)) each target person with respect to a normal vector of the ground plane, and generating the 3D pose data of the each target person by the PR, and
a rotation angle is randomly determined between −45 degrees and 45 degrees.

4. The training data augmentation method of claim 1, wherein
the generating of the 3D pose data includes moving (ground plane translation (GPT)) the ground plane along a principal axis of the camera, and generating the 3D pose data of each target person by the GPT, and
a movement amount is determined by considering relative positions of a plurality of persons from the camera.

5. The training data augmentation method of claim 1, wherein
the generating of the 3D pose data includes rotating (ground plane rotation (GPR)) the ground plane toward or away from the camera, and generating the 3D pose data of each target person by the GPR, and
a rotation amount is randomly determined between −30 degrees and 30 degrees.

6. The training data augmentation method according to claim 1, wherein
an augmentation order of the training data follows an order of the PR, GPT, GPR, and PT, and in the PT, center coordinates of the each target person are randomly determined within a range in which the center coordinates are located in front of the camera and have values allowing the center coordinates to be projected onto an image plane.

7. The training data augmentation method of claim 1, further comprising:
expressing a volume of each target person as a set of 3D balls centered on each joint (each key point),
wherein the balls are each expressed at an equal size in each joint of one target person, and
the balls are projected onto a two-dimensional image plane as circles, and a radius of each of the circles is inversely proportional to a distance of a three-dimensional ball from the camera.

8. The training data augmentation method of claim 7, further comprising:
measuring a distance between centers of a first circle corresponding to a first person and a second circle corresponding to a second person; and
determining whether the first person covers the second person is determined according to a comparison between a radius of the first circle of the first person closer to the camera and a center-to-center distance between the first circle and the second circle.

9. The training data augmentation method of claim 8, wherein
the determining whether the first person obscures the second person includes determining that, when the distance between the centers of the first circle and the second circle is less than the radius of the first circle of the first person that is closer to the camera, the first person occludes the second person.

10. A training data augmentation device for 3D pose estimation, the training data augmentation device comprising:
a processor; and
a memory connected to the processor and storing at least one code executed by the processor,
wherein the processor is configured to perform an operation of collecting foot coordinates of each of persons appearing in a two-dimensional image, an operation of estimating a ground plane in a three-dimensional space based on the collected foot coordinates, an operation of generating three-dimensional pose data by moving or rotating at least one person or moving or rotating the ground plane based on two basis vectors perpendicular to a normal vector of the ground plane, an operation of mapping the 3D pose data to two-dimensional pose data based on a focal length of a camera obtained by capturing the two-dimensional image and a principal point of coordinates of the two-dimensional image, and an operation of acquiring a pair of the 3D pose data and two-dimensional pose data as training data.

11. The training data augmentation device of claim 10, wherein
the processor is further configured to perform the operation of generating the 3D pose data including an operation (person translation (PT)) of moving each target person along the two basis vectors representing the ground plane in a 3D space and an operation of generating the 3D pose data of the each target person by the PT, and
a movement amount is randomly determined randomly within a range in which a central joint position of the each target person is located in front of a camera and projected onto an image plane.

12. The training data augmentation device of claim 10, wherein
the processor is further configured to perform the operation of generating the 3D pose data including an operation (person rotation (PR)) of rotating each target person with respect to a normal vector of the ground plane and an operation of generating the 3D pose data of the each target person by the PR, and
a rotation angle is randomly determined between −45 degrees and 45 degrees.

13. The training data augmentation device of claim 10, wherein
the processor is further configured to perform the operation of generating the 3D pose data including an operation of moving (ground plane translation (GPT)) the ground plane along a principal axis of the camera and an operation of generating the 3D pose data of each target person by the GPT, and
a movement amount is determined by considering relative positions of a plurality of persons from the camera.

14. The training data augmentation device of claim 10, wherein
the processor is further configured to perform the operation of generating the 3D pose data including an operation (ground plane rotation (GPR)) of rotating the ground plane toward or away from the camera and an operation of generating the 3D pose data of each target person by the GPR, and
a rotation amount is randomly determined between −30 degrees and 30 degrees.

15. The training data augmentation device according to claim 10, wherein
an augmentation order of the training data follows an order of the PR, GPT, GPR, and PT, and in the PT, center coordinates of the each target person are randomly determined within a range in which the center coordinates are located in front of the camera and have values allowing the center coordinates to be projected onto an image plane.

16. The training data augmentation device of claim 10, further comprising:
an operation of expressing a volume of each target person as a set of 3D balls centered on each joint (each key point),
wherein the balls are each expressed at an equal size in each joint of one target person, and
the balls are projected onto a two-dimensional image plane as circles, and a radius of each of the circles is inversely proportional to a distance of a three-dimensional ball from the camera.

17. The training data augmentation device of claim 16, further comprising:
an operation of measuring a distance between centers of a first circle corresponding to a first person and a second circle corresponding to a second person, and
an operation of determining whether the first person covers the second person is determined according to a comparison between a radius of the first circle of the first person closer to the camera and a center-to-center distance between the first circle and the second circle.

18. The training data augmentation device of claim 17, wherein
the operation of determining whether the first person obscures the second person includes an operation of determining that, when the distance between the centers of the first circle and the second circle is less than the radius of the first circle of the first person that is closer to the camera, the first person occludes the second person.
